(19) United States
(12) Patent Application Publication
(10) Pub. No.: US 2021/0342348 A1
(43) Pub. Date: Nov. 4, 2021

(54) METHOD FOR PARSING QUERY, ELECTRONIC DEVICE AND READABLE STORAGE MEDIUM

(71) Applicant: BAIDU ONLINE NETWORK TECHNOLOGY (BEIJING) CO., LTD, Beijing (CN)

(72) Inventors: Xiaonan HE, Beijing (CN); Qiang JU, Beijing (CN); Jian XIE, Beijing (CN)

(73) Assignee: BAIDU ONLINE NETWORK TECHNOLOGY (BEIJING) CO., LTD, Beijing (CN)

(21) Appl. No.: 16/950,066

(22) Filed: Nov. 17, 2020

(30) Foreign Application Priority Data
Apr. 29, 2020 (CN) 202010358793X

(51) Int. Cl. G06F 16/2452; G06F 16/242; G06F 16/22; G06F 16/28

(52) U.S. Cl. CPC G06F 16/24522; G06F 16/243; G06F 16/287; G06F 16/288; G06F 16/2246

(57) ABSTRACT

A method for parsing a query, an electronic device and a readable storage medium, which relate to the field of natural language processing technologies, are disclosed. According to some embodiments, the method includes: acquiring the query input by a user; constructing a syntactic dependency tree of the query; matching the syntactic dependency tree of the query with syntactic dependency trees of preset templates, and determining a target template according to the matching result; and marking a slot operator of a slot in the query using the target template, and the marked slot operator represents a logical relationship applied to the slot in the query. With the technical solution, the logical relationship applied to the slot in the query may be acquired, and the accuracy of query parse may be improved.

### CROSS-REFERENCE TO RELATED APPLICATIONS

The present application claims the priority and benefit of Chinese Patent Application No. 202010358793X, filed on Apr. 29, 2020. The disclosure of the above application is incorporated herein by reference in its entirety.

### TECHNICAL FIELD

The present application relates to the field of computer technologies, and particularly to a method for parsing a query, an electronic device and a readable storage medium in the field of natural language processing technologies.

### BACKGROUND

In a voice conversation scenario, the process of parsing a query by a conversational system includes: performing semantics parsing on the query of a user, recognizing the parsing result as a natural language understanding (NLU) result, searching according to the NLU result, and then returning the search result to the user.

### SUMMARY

In order to solve the technical problem, the present application provides a method for parsing a query, including: acquiring the query input by a user; constructing a syntactic dependency tree of the query; matching the syntactic dependency tree of the query with syntactic dependency trees of preset templates, and determining a target template according to the matching result; and marking a slot operator of a slot in the query using the target template, and the marked slot operator represents a logical relationship applied to the slot in the query. With the present application, the logical relationship applied to the slot in the query may be acquired, thereby improving the accuracy of query parse.

In order to solve the technical problem, the present application provides an apparatus for parsing a query, including: an acquiring unit configured to acquire the query input by a user; a constructing unit configured to construct a syntactic dependency tree of the query; a matching unit configured to match the syntactic dependency tree of the query with syntactic dependency trees of preset templates, and determine a target template according to the matching result; and a parsing unit configured to mark a slot operator of a slot in the query using the target template, and the marked slot operator represents a logical relationship applied to the slot in the query.

An embodiment of the above-mentioned application has the following advantages or beneficial effects: with the present application, the logical relationship applied to the slot in the query may be acquired, thereby improving the accuracy of the query parse. Since the technical means that the slot operator of the slot in the query is marked using the determined target template after the syntactic dependency trees of the query and the preset templates are matched is adopted, the technical problem that the logical relationship applied to the slot in the query is unable to be parsed in the prior art is solved, and the technical effect of improving the accuracy of the query parse is achieved.

Other effects of the above-mentioned alternatives will be described below in conjunction with embodiments.

### BRIEF DESCRIPTION OF THE DRAWINGS

The drawings are used for better understanding the present solution and do not constitute a limitation of the present application. In the drawings:

FIG. 1 is a schematic diagram according to a first embodiment of the present application:

FIG. 2 is a schematic diagram according to a second embodiment of the present application;

FIG. 3 is a schematic diagram according to a third embodiment of the present application;

FIG. 4 is a schematic diagram according to a fourth embodiment of the present application; and

FIG. 5 is a block diagram of an electronic device configured to implement a method for parsing a query according to the embodiments of the present application.

### DETAILED DESCRIPTION

The following part will illustrate exemplary embodiments of the present application with reference to the figures, including various details of the embodiments of the present application for a better understanding. The embodiments should be regarded only as exemplary ones. Therefore, those skilled in the art should appreciate that various changes or modifications can be made with respect the embodiments described herein without departing from the scope and spirit of the present application. Similarly, for clarity and conciseness, the descriptions of the known functions and structures are omitted in the descriptions below.

Generally, the query input by the user is complete; that is, the semantics of the query may be accurately understood from the query itself, and such a query is called “a single-round query”. However, in some voice conversation scenarios, after conversing with a smart voice device, the user often inputs the query by means of an abridged expression in a following statement. Since such a query is incomplete due to lack of sentence constituents, the intention of the user is unable to be determined only by the input query, and such a query is called “a multi-round query”.

Currently, in the prior art, the multi-round query is still parsed with a method for parsing the single-round query, but since the multi-round query is usually incomplete, the parsing error rate is higher when the multi-round query is parsed with the method for parsing the single-round query.

For example, if the query is “ [symbol] (pu) [symbol] (tong) [symbol] (ban) [symbol] (de) [symbol] (bu) [symbol] (yao) [symbol] (zhi) [symbol] (yao) [symbol] (gao) [symbol] (qing) [symbol] (ban)(which means: normal version is not required only high-definition version)”, only slots “ [symbol] (pu) [symbol] (tong) [symbol] (ban)(which means: normal version)” and “ [symbol] (gao) [symbol] (qing) [symbol] (ban)(which means: high-definition version)” are able to be acquired using the prior art, but a logical relationship applied to the slots is unable to be acquired; that is, the negative slot and the positive slot are unable to be determined, such that the querying result is unable to be acquired accurately, and the voice interaction experience of the user is reduced.

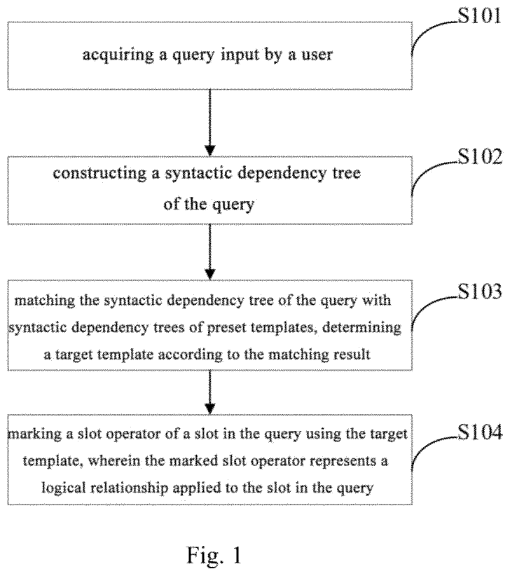

FIG. 1 is a schematic diagram according to a first embodiment of the present application. As shown in FIG. 1, a method for parsing a query according to this embodiment may include the following steps:

S101: acquiring the query input by a user;

S102: constructing a syntactic dependency tree of the query;

S103: matching the syntactic dependency tree of the query with syntactic dependency trees of preset templates, and determining a target template according to the matching result; and

S104: marking a slot operator of a slot in the query using the target template, wherein the marked slot operator represents a logical relationship applied to the slot in the query.

In the method for parsing a query according to this embodiment, the target template is first determined according to the syntactic dependency trees of the query and the preset templates, and then, the slot operator of the slot in the query is marked using the determined target template, such that the logical relationship applied to the slot in the query may be acquired, and the aim of accurately parsing the query, particularly a multi-round query input by the user is achieved, thereby increasing the accuracy and the recall rate of acquiring a search result corresponding to the query.

The acquired query in this embodiment is a query input by the user in a voice interaction process with a smart device, and after parsing the query input by the user, the smart device acquires the search result according to the parsing result of the query for display to the user.

Generally, the query input by the user may express a demand which is relatively complete, for example, a query “ [symbol] (wo) [symbol] (xiang) [symbol] (ting) [symbol] (wang) [symbol] (li) [symbol] (hong) [symbol] (de) [symbol] (ge)(which means: I want to listen to a song of Leehom Wang)”, which has complete sentence constituents, such as a subject, a predicate, an object, or the like, the semantics of the query may be accurately understood from the query itself, and such a query is called “a single-round query”.

In some application scenarios, for example, the user has spoken to listen to music or the smart device is playing music, the user will often input the query in an abridged expression form in a following statement. The abridged expression indicates that the input query lacks the object or other sentence constituents, such that the semantics of the query is unable to be accurately understood from the query itself, and such a query is called “a multi-round query”, for example, abridged statements “ [symbol] (huan) [symbol] (ge) [symbol] (zhou) [symbol] (jie) [symbol] (lun) [symbol] (de)(which means: change to Jay Chou's)”, “ [symbol] (yao) [symbol] (ying) [symbol] wen) [symbol] (de)(which means: English ones)”, or the like.

In this embodiment, the query acquired in S101 is preferably a multi-round query, i.e., a query with an incomplete semantic expression. For the single-round query, the semantics of the query may be parsed with an existing natural language understanding (NLU) method, such as an intention classification model or a slot identification model.

In this embodiment, after the query input by the user is acquired, the syntactic dependency tree of the query is constructed according to the acquired query, and the constructed syntactic dependency tree contains syntactic information of the query. The syntactic dependency tree constructed in this embodiment has a tree structure, and includes a plurality of nodes and sides between the nodes, each node represents a semantic element, and the sides between the nodes represent dependency relationships between the words/phrases, such as a head relationship (HED), a subject-predicate relationship (SBV), a verb-object relationship (VOB), an attribute-head relationship (ATT), or the like.

Before the syntactic dependency tree of the query is constructed, S102 in this embodiment may further include: determining whether the acquired query meets a preset requirement; and if yes, continuing to execute the operation of constructing the syntactic dependency tree of the query, otherwise, parsing the query directly. That is, in this embodiment, the queries input by the user may be screened, such that only the query meeting the preset requirement is parsed by analyzing the syntactic dependency tree, thus further improving the accuracy of query parse.

The preset requirement in this embodiment may be that the acquired query has no recall result; that is, in S102, the syntactic dependency tree is constructed for the query for which the querying result is unable to be acquired; or that the acquired query lacks sentence constituents; that is, in S102, the syntactic dependency tree is constructed for the incomplete query; or that the acquired query has a specific statement form; that is, in S102, the syntactic dependency tree is constructed for the query in the form of “ [symbol] (bu) [symbol] (yao)xx [symbol] (de)(no (sth of) xx)”, “xx [symbol] (de) [symbol] (bu) [symbol] (yao)(“(sth of) xx is not required)”, “ [symbol] (lai) [symbol] (ge)xx [symbol] (de)rovide (sth of) xx)”, or the like.

Specifically, in S102 in this embodiment, the syntactic dependency tree of the acquired query may be constructed by: performing word segmentation on the acquired query to acquire semantic elements (each including at least one word) in the query and the part of speech of each semantic element; performing syntactic dependency analysis on the semantic elements in the query to determine the dependency relationships between the semantic elements; and constructing the syntactic dependency tree of the query according to the semantic elements in the query, the part of speech of each word and the dependency relationships between the semantic elements.

For example, if the acquired query is “ [symbol] (pu) [symbol] (tong) [symbol] (ban) [symbol] (de) [symbol] (bu) [symbol] (yao)(which means: common version is not required)”, after word segmentation of the query, three word segmentation results “ [symbol] (pu) [symbol] (tong) [symbol] (ban)(which means: common version)|n”, “ [symbol] (de)(is)|u” and “ [symbol] (bu) [symbol] (yao)(not required)|v” are obtained, and n (noun), u (auxiliary word) and v (verb) are the parts of speech corresponding to the words respectively. By syntactic dependency analysis, the acquired dependency relationships between the semantic elements may include DE ( [symbol] (de)|u-2, [symbol] (pu) [symbol] (tong) [symbol] (ban)(common version)|n-1), HED (Root-0, [symbol] (de)|u-2) and IC ( [symbol] (de)|u-2, [symbol] (bu) [symbol] (yao)(not required)|v-3); the first semantic element in the parentheses represents a parent-node semantic element in the syntactic dependency tree, and the second semantic element represents a child-node semantic element in the syntactic dependency tree; the number after each semantic element represents the position of the semantic element in the query, and for example, “ [symbol] (pu) [symbol] (tong) [symbol] (ban)(normal version)|n-1” represents that the position of “ [symbol] (pu) [symbol] (tong) [symbol] (ban)(normal version)” in the query is 1, i.e., the first semantic element; Root represents a root node of the syntactic dependency tree, and is a virtual node. After the dependency relationships between the words are acquired, the syntactic dependency tree of the query is constructed according to the semantic elements, the parts of speech ( [symbol] (pu) [symbol] (tong) [symbol] (ban)(common version)|n, [symbol] (de)|u, [symbol] (bu) [symbol] (yao)(not required)|v) of the semantic elements and the dependency relationships (DE, HED, IC) between the semantic elements.

In this embodiment, after constructed, the syntactic dependency tree of the query is matched with the syntactic dependency trees of the preset templates, so as to select the target template from the preset templates according to the matching result, and the selected target template is configured to parse the query, so as to acquire the slot operator of the slot in the query.

In this embodiment, a plurality of templates are preset, and each template includes a template name, template confidence and the syntactic dependency tree of the template. The template name corresponds to a processing method after the query is parsed with the template, and for example, the template with the template name “[P:negate]” indicates that the processing method after the query is parsed is a negating operation; since corresponding to the same template name, a plurality of templates with the same name may be ranked according to the template confidence; the syntactic dependency tree of the template contains n non-Root nodes, and defines nodes included in the template, the position of each node, the position of a parent node of each node, the dependency relationship between each node and the parent node, the part of speech of each node, word contents of each node, an operator corresponding to each node, or the like.

For example, the template corresponding to the negating operation has a pattern “[P:negate]-90.0-1|0|null|null|[D:negate]|negate-2|1|VOB|null|null|null-3|2|DE|null|null|null”, and contains 3 non-Root nodes (represented by numbers 1, 2 and 3 respectively), wherein [P:negate] is the template name of the template, 90.0 is the confidence of the template, and “1|0|null|null|[D:negate]|negate” in the syntactic dependency tree corresponds to the first node defined by the template, and defines the parent node of the node as Root node 0, the dependency relationship between the node and the parent node as “null”, the part of speech of the node as “null”, the word contents of the node as one semantic element in a [D:negate] dictionary (which may contain words corresponding to negating, such as [symbol] (bie), [symbol] (bu), [symbol] (bu) [symbol] (xiang), [symbol] (bu) [symbol] (yao), [symbol] (bu) [symbol] (xiang) [symbol] (kan)(no, not, not required, not needed, not want to see, or the like), and the operator corresponding to the node as “negate”.

In this embodiment, when the syntactic dependency tree of the query is matched with the syntactic dependency trees of the preset templates and the target template is determined according to the matching result, the target template may be determined by matching a tree diagram of the syntactic dependency tree; it is also possible to construct a classification model, the syntactic dependency tree of the query and the syntactic dependency trees of the preset templates are input into the classification model, and the target template is determined according to an output result of the classification model.

It may be understood that the number of the determined target templates may be one or more in this embodiment. After a plurality of target templates are determined, the method according to this embodiment may further include: ranking the target templates with the same names according to the confidence thereof; and according to the ranking result, reserving the first target templates under different names. That is, with this embodiment, plural target templates with the same name may be avoided, and the plural acquired target templates are guaranteed to correspond to different template names, thereby improving the accuracy of parsing the query using the target templates.

In this embodiment, after the target template is determined, the slot operator of the slot in the query is marked using the determined target template, and the marked slot operator represents the logical relationship applied to the slot in the query. The slot operator corresponds to operations, such as addition, deletion, modification, or the like, in the data querying process; that is, the slot operator is used for describing the logical relationship applied to the specific slot by the user in the query.

For example, if the query is “ [symbol] (bu) [symbol] (yao) [symbol] (zhou) [symbol] (jie) [symbol] (lun) [symbol] (chang) [symbol] (de)(not need a song of Jay Chou)”, the slot is “singer [symbol] (zhou) [symbol] (jie) [symbol] (lun)(Jay Chou)”, and if the slot operator of the slot is “negate” using the target template, it indicates that the logical relationship applied to “ [symbol] (zhou) [symbol] (jie) [symbol] (lun)(Jay Chou)” in the query is negative, which indicates that the user does not want to listen to the song of Jay Chou.

It may be understood that in this embodiment, the type of the slot operator may be modified according to an actual application scenario, and different types of slot operators may also be added according to actual demands of the user. The type of the slot operator may include negative identification, replacement identification, only identification, common-demonstrative-pronoun identification, other-demonstrative-pronoun identification, similarity relationship identification, supplementary slot identification, or the like.

Specifically, in this embodiment, the slot operator of the slot in the query may be marked using the target template by: making nodes and sides between the nodes of the syntactic dependency tree of the target template to correspond respectively to the nodes and the sides between the nodes in the syntactic dependency tree of the query; and acquiring an operator of each node in the syntactic dependency tree of the target template as the slot operator of the slot corresponding to the same node in the syntactic dependency tree of the query. Therefore, in this embodiment, by means of marking the slot operator of the slot in the query using the target template, the parsing speed and the parsing efficiency of the query may be improved.

In addition, in this embodiment, when the slot operator of the slot in the query is marked using the target template, the name of the target template may also be directly used as the slot operator of the slot in the query.

In the method for parsing a query according to this embodiment, after the syntactic dependency tree of the query is matched with the syntactic dependency trees of the preset templates, the slot operator of the slot in the query is marked using the determined target template, such that the logical relationship applied to the slot in the query may be obtained, thereby improving the parsing accuracy of the query; after the slot operator of the slot in the query is parsed, a search action is performed for the query in conjunction with contents of a previous query, and therefore, a more accurate search result is acquired and returned to the user.

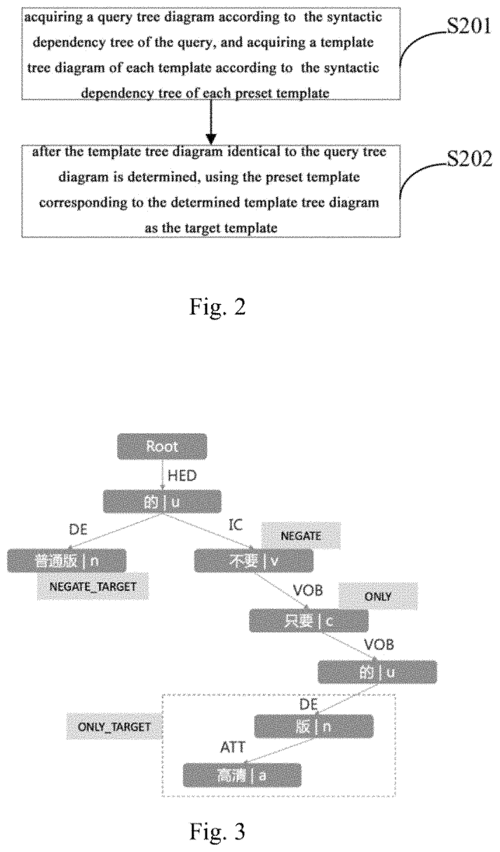

FIG. 2 is a schematic diagram according to a second embodiment of the present application. As shown in FIG. 2, in this embodiment, S103 of matching the syntactic dependency tree of the query with syntactic dependency trees of preset templates and determining a target template according to the matching result specifically includes:

S201: acquiring a query tree diagram according to the syntactic dependency tree of the query, and acquiring a template tree diagram of each template according to the syntactic dependency tree of each preset template.

The acquired query tree diagram in this embodiment includes at least one of an overall tree diagram of the syntactic dependency tree corresponding to the query and a subtree diagram of a subtree in the syntactic dependency tree corresponding to the query, and includes a tree structure of the syntactic dependency tree, the nodes in the syntactic dependency tree, and contents corresponding to the nodes. That is, in this embodiment, the target template is selected from the preset templates by matching the tree diagrams of the syntactic dependency trees.

S202: after the template tree diagram identical to the query tree diagram is determined, using the preset template corresponding to the determined template tree diagram as the target template.

In this embodiment, after the query tree diagram corresponding to the query and the template tree diagrams corresponding to the preset templates are acquired, by comparing the tree diagrams, the template tree diagram identical to the acquired query tree diagram is determined first, and then, the preset template corresponding to the determined template tree diagram is used as the target template.

Since the acquired query tree diagram includes the overall tree diagram and the subtree diagram of the syntactic dependency tree of the query, the tree diagrams may be matched completely or partially in this embodiment, thereby improving the matching accuracy of the target template. The complete match of the tree diagrams means that the overall tree diagram of the query is the same as the template tree diagram of the preset template; the partial match of the tree diagrams means that the template tree diagram of the preset template is the same as the subtree diagram of the query.

In addition, since the contents corresponding to each node, such as the part of speech of each node, the word content of each node, the dependency relationship between each node and the parent node, or the like, are further defined in the syntactic dependency tree of the preset template, in this embodiment, the template tree diagram identical to the query tree diagram may be determined in detail with the above-mentioned contents, thereby further improving the accuracy of the acquired target template.

FIG. 3 is a schematic diagram according to a third embodiment of the present application. FIG. 3 shows the syntactic dependency tree and the parsing result of the query “ [symbol] (pu) [symbol] (tong) [symbol] (ban) [symbol] (de) [symbol] (bu) [symbol] (yao) [symbol] (zhi) [symbol] (yao) [symbol] (gao) [symbol] (qing) [symbol] (ban) [symbol] (de)normal version is not required and only need high-definition version)”, and “NEGATE” corresponding to “ [symbol] (bu) [symbol] (yao)(not required)|v”, “NEGATE TARGATE” corresponding to “ [symbol] (pu) [symbol] tong) [symbol] (ban)(normal version)|n”, “ [symbol] (zhi) [symbol] (yao)(ONLY)” corresponding to “only|c” and “ONLY_TARGATE” corresponding to “ [symbol] (gao) [symbol] (qing)(high-definition)|a, [symbol] (ban)(version)|n” are slot operators of the slots in the query marked using the target template.

Here, an example of the target template corresponding to the query is illustrated: 1) the complete matching template is “[P:FULL_MATCHED]-99.0-1|2DE|n|[D:HD_TYPE]|null-2|0|HED|u [symbol] null-3|2|IC|v|[D:NEGATE]|negate-4|3|VOB|c|[D:ONLY]|only-5|6|ATT|a|[D:HD_TYPE]|null-6|4|VOB|n| [symbol] null-7|4|MT|u [symbol] null”, and the tree diagram of the template is completely matched with the overall tree diagram of the above-mentioned query; the partial matching template may contain a negating template and an only template; the negating template is “[P:negate]-95.0-1|2|DE|n|null|negate_target-2|0|HED|u| [symbol] |null-3|2|null|v|[D:NEGATE]|negate”, and the tree diagram of the template is matched with the tree diagram of one subtree ( [symbol] (pu) [symbol] (tong) [symbol] (ban) [symbol] (de) [symbol] (bu) [symbol] (yao)(normal version is not required)) in the above-mentioned query; the only template is “[P:only]-88.0-1|0|null|c|[D:ONLY]|only-2|3|null|null [symbol] null-3|1|MT|u| [symbol] null”, and the tree diagram of the template is matched with the tree diagram of one subtree ( [symbol] (zhi) [symbol] yao) [symbol] (gao) [symbol] (qing) [symbol] (ban)(only need high-definition version)) in the above-mentioned query.

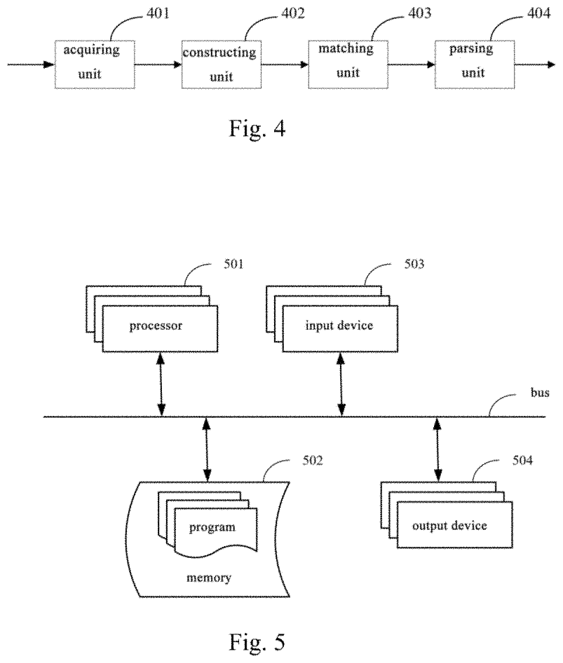

FIG. 4 is a schematic diagram according to a fourth embodiment of the present application. As shown in FIG. 4, an apparatus for parsing a query according to this embodiment may include: an acquiring unit 401 configured to acquire the query input by a user: a constructing unit 402 configured to construct a syntactic dependency tree of the query; a matching unit 403 configured to match the syntactic dependency tree of the query with syntactic dependency trees of preset templates, and determine a target template according to the matching result: and a parsing unit 404 configured to mark a slot operator of a slot in the query using the target template, and the marked slot operator represents a logical relationship applied to the slot in the query.

The query acquired by the acquiring unit 401 in this embodiment is a query input by the user in a voice interaction process with a smart device, and after parsing the query input by the user, the smart device acquires the querying result according to the parsing result of the query for display to the user.

In this embodiment, the query acquired by the acquiring unit 401 is preferably a multi-round query, i.e., a query with an incomplete semantic expression. For the single-round query, the semantics of the query may be parsed with an existing natural language understanding (NLU) method, such as an intention classification model or a slot identification model.

In this embodiment, after the query input by the user is acquired, the syntactic dependency tree of the query is constructed by the constructing unit 402 according to the acquired query, and the constructed syntactic dependency tree contains syntactic information of the query. The syntactic dependency tree constructed in this embodiment has a tree structure, and includes a plurality of nodes and sides between the nodes, each node represents a semantic element, and the sides between the nodes represent dependency relationships between the semantic elements, such as a head relationship (HED), a subject-predicate relationship (SBV), a verb-object relationship (VOB), an attribute-head relationship (ATT), or the like.

Before the syntactic dependency tree of the query is constructed, the constructing unit 402 in this embodiment may be further configured to: determine whether the acquired query meets a preset requirement; and if yes, continue to execute the operation of constructing the syntactic dependency tree of the query, otherwise, parse the query directly. That is, in this embodiment, the queries input by the user may be screened, such that only the query meeting the preset requirement is parsed by analyzing the syntactic dependency tree, thus further improving the accuracy of query parse.

The preset requirement of the constructing unit 402 in this embodiment may be that the acquired query has no recall result; that is, the constructing unit 402 constructs the syntactic dependency tree for the query for which the querying result is unable to be acquired; or that the acquired query lacks sentence constituents; that is, the constructing unit 402 constructs the syntactic dependency tree for the incomplete query; or that the acquired query has a specific statement form; that is the constructing unit 402 constructs the syntactic dependency tree for the query in the form of “ [symbol] (bu) [symbol] (yao)XX [symbol] (de) (no (sth of) xx)”, “xx [symbol] (de) [symbol] (bu) [symbol] yao) ((sth of) xx is not required)”, “ [symbol] (lai) [symbol] (ge)xx [symbol] (de)(provide (sth of) xx)”, or the like.

Specifically, the constructing unit 402 in this embodiment may construct the syntactic dependency tree of the acquired query by: performing word segmentation on the acquired query to acquire semantic elements in the query and the part of speech of each semantic element; performing syntactic dependency analysis on the semantic elements in the query to determine the dependency relationships between the semantic elements; and constructing the syntactic dependency tree of the query according to the semantic elements in the query, the part of speech of each semantic element and the dependency relationships between the semantic elements.

In this embodiment, after constructed, the syntactic dependency tree of the query is matched with the syntactic dependency trees of the preset templates by the matching unit 403, so as to select the target template from the preset templates according to the matching result, and the selected target template is configured to parse the query, so as to acquire the slot operator of the slot in the query.

A plurality of templates are preset in the matching unit 403 in this embodiment, and each template includes a template name, template confidence and the syntactic dependency tree of the template. The template name corresponds to a processing method after the query is parsed with the template, and for example, the template with the template name “[P:negate]” indicates that the processing method after the query is parsed is a negating operation; since corresponding to the same template name, a plurality of templates with the same name may be ranked according to the template confidence; the syntactic dependency tree of the template contains n non-Root nodes, and defines nodes included in the template, the position of each node, the position of a parent node of each node, the dependency relationship between each node and the parent node, the part of speech of each node, word contents of each node, an operator corresponding to each node, or the like.

When the matching unit 403 in this embodiment matches the syntactic dependency tree of the query with the syntactic dependency trees of the preset templates and determines the target template according to the matching result, the target template may be determined by matching a tree diagram of the syntactic dependency tree; it is also possible to construct a classification model, the syntactic dependency tree of the query and the syntactic dependency trees of the preset templates are input into the classification model, and the target template is determined according to an output result of the classification model.

Optionally, the matching unit 403 in this embodiment may match the syntactic dependency tree of the query with the syntactic dependency trees of the preset templates and determine the target template according to the matching result by: acquiring a query tree diagram according to the syntactic dependency tree of the query, and acquiring a template tree diagram of each template according to the syntactic dependency tree of each preset template; and after the template tree diagram identical to the query tree diagram is determined, using the preset template corresponding to the determined template tree diagram as the target template. That is, the matching unit 403 in this embodiment selects the target template from the preset templates by matching the tree diagrams of the syntactic dependency trees.

The query tree diagram acquired by the matching unit 403 in this embodiment includes at least one of an overall tree diagram of the syntactic dependency tree corresponding to the query and a subtree diagram of a subtree in the syntactic dependency tree corresponding to the query, and includes a tree structure of the syntactic dependency tree, the nodes in the syntactic dependency tree, and contents corresponding to the nodes.

Since the acquired query tree diagram includes the overall tree diagram and the subtree diagram of the syntactic dependency tree of the query, the tree diagrams may be completely or partially matched by the matching unit 403 in this embodiment. The complete match of the tree diagrams means that the overall tree diagram of the query is the same as the template tree diagram of the preset template; the partial match of the tree diagrams means that the template tree diagram of the preset template is the same as the subtree diagram of the query.

In addition, since the contents corresponding to each node, such as the part of speech of each node, the word content of each node, the dependency relationship between each node and the parent node, or the like, are further defined in the syntactic dependency tree of the preset template, the matching unit 403 in this embodiment may determine the template tree diagram identical to the query tree diagram in detail with the above-mentioned contents, thereby further improving the accuracy of the acquired target template.

It may be understood that the number of the target templates determined by the matching unit 403 in this embodiment may be one or more. After determining a plurality of target templates, the matching unit 403 according to this embodiment may be further configured to: rank the target templates with the same names according to the confidence thereof; and according to the ranking result, reserve the first target templates under different names. That is, with the matching unit 403 in this embodiment, plural target templates with the same name may be avoided, and the plural acquired target templates are guaranteed to correspond to different template names, thereby improving the accuracy of parsing the query using the target templates.

In this embodiment, after the target template is determined, the slot operator of the slot in the query is marked by the parsing unit 404 using the determined target template, and the marked slot operator represents the logical relationship applied to the slot in the query. The slot operator corresponds to operations, such as addition, deletion, modification, or the like, in the data querying process; that is, the slot operator is used for describing the logical relationship applied to the specific slot by the user in the query.

Specifically, the parsing unit 404 in this embodiment may mark the slot operator of the slot in the query using the target template by: making nodes and sides between the nodes in the syntactic dependency tree of the target template to correspond respectively to the nodes and the sides between the nodes in the syntactic dependency tree of the query; and acquiring an operator of each node in the syntactic dependency tree of the target template as the slot operator of the slot corresponding to the same node in the syntactic dependency tree of the query.

In addition, when the parsing unit 404 in this embodiment marks the slot operator of the slot in the query using the target template, the name of the target template may also be directly used as the slot operator of the slot in the query.

According to the embodiments of the present application, there are also provided an electronic device and a computer readable storage medium.

FIG. 5 is a block diagram of an electronic device configured to implement the method for parsing a query according to the embodiments of the present application. The electronic device is intended to represent various forms of digital computers, such as laptop computers, desktop computers, workstations, personal digital assistants, servers, blade servers, mainframe computers, and other appropriate computers. The electronic device may also represent various forms of mobile apparatuses, such as personal digital processors, cellular telephones, smart phones, wearable devices, and other similar computing apparatuses. The components shown herein, their connections and relationships, and their functions, are meant to be exemplary only, and are not meant to limit implementation of the present application described and/or claimed herein.

As shown in FIG. 5, the electronic device includes one or more processors 501, a memory 502, and interfaces configured to connect the various components, including high-speed interfaces and low-speed interfaces. The various components are interconnected using different buses and may be mounted at a common motherboard or in other manners as desired. The processor may process instructions for execution within the electronic device, including instructions stored in or at the memory to display graphical information for a GUI at an external input/output apparatus, such as a display device coupled to the interface. In other implementations, plural processors and/or plural buses may be used with plural memories, if desired. Also, plural electronic devices may be connected, with each device providing some of necessary operations (for example, as a server array, a group of blade servers, or a multi-processor system). In FIG. 5, one processor 501 is taken as an example.

The memory 502 is configured as the non-transitory computer readable storage medium according to the present application. The memory stores instructions executable by the at least one processor to cause the at least one processor to perform a method for parsing a query according to the present application. The non-transitory computer readable storage medium according to the present application stores computer instructions for causing a computer to perform the method for parsing the query according to the present application.

The memory 502 which is a non-transitory computer readable storage medium may be configured to store non-transitory software programs, non-transitory computer executable programs and modules, such as program instructions/modules corresponding to the method for parsing the query according to the embodiments of the present application (for example, the acquiring unit 401, the constructing unit 402, the matching unit 403 and the parsing unit 404 shown in FIG. 4). The processor 501 executes various functional applications and data processing of a server, that is, implements the method for parsing the query according to the above-mentioned embodiments, by running the non-transitory software programs, instructions, and modules stored in the memory 502.

The memory 502 may include a program storage area and a data storage area, wherein the program storage area may store an operating system and an application program required for at least one function; the data storage area may store data created according to use of the electronic device, or the like. Furthermore, the memory 502 may include a high-speed random access memory, or a non-transitory memory, such as at least one magnetic disk storage device, a flash memory device, or other non-transitory solid state storage devices. In some embodiments, optionally, the memory 502 may include memories remote from the processor 501, and such remote memories may be connected to the electronic device for the method for parsing the query via a network. Examples of such a network include, but are not limited to, the Internet, intranets, local area networks, mobile communication networks, and combinations thereof.

The electronic device for the method for parsing the query may further include an input device 503 and an output device 504. The processor 501, the memory 502, the input device 503 and the output device 504 may be connected by a bus or other means, and FIG. 5 takes the connection by a bus as an example.

The input device 503 may receive input numeric or character information and generate key signal input related to user settings and function control of the electronic device for the method for parsing the query, such as a touch screen, a keypad, a mouse, a track pad, a touch pad, a pointing stick, one or more mouse buttons, a trackball, a joystick, or the like. The output device 504 may include a display device, an auxiliary lighting device (for example, an LED) and a tactile feedback device (for example, a vibrating motor), or the like. The display device may include, but is not limited to, a liquid crystal display (LCD), a light emitting diode (LED) display, and a plasma display. In some implementations, the display device may be a touch screen.

Various implementations of the systems and technologies described here may be implemented in digital electronic circuitry, integrated circuitry, ASICs (application specific integrated circuits), computer hardware, firmware, software, and/or combinations thereof. These various implementations may be implemented in one or more computer programs which are executable and/or interpretable on a programmable system including at least one programmable processor, and the programmable processor may be special or general, and may receive data and instructions from, and transmitting data and instructions to, a storage system, at least one input device, and at least one output device.

These computer programs (also known as programs, software, software applications, or codes) include machine instructions for a programmable processor, and may be implemented using high-level procedural and/or object-oriented programming languages, and/or assembly/machine languages. As used herein, the terms “machine readable medium” and “computer readable medium” refer to any computer program product, device and/or apparatus (for example, magnetic discs, optical disks, memories, programmable logic devices (PLDs)) for providing machine instructions and/or data to a programmable processor, including a machine readable medium which receives machine instructions as a machine readable signal. The term “machine readable signal” refers to any signal for providing machine instructions and/or data to a programmable processor.

To provide interaction with a user, the systems and technologies described here may be implemented on a computer having: a display device (for example, a CRT (cathode ray tube) or LCD (liquid crystal display) monitor) for displaying information to a user; and a keyboard and a pointing device (for example, a mouse or a trackball) by which a user may provide input to the computer. Other kinds of devices may also be used to provide interaction with a user; for example, feedback provided to a user may be any form of sensory feedback (for example, visual feedback, auditory feedback, or tactile feedback): and input from a user may be received in any form (including acoustic, voice or tactile input).

The systems and technologies described here may be implemented in a computing system (for example, as a data server) which includes a back-end component, or a computing system (for example, an application server) which includes a middleware component, or a computing system (for example, a user computer having a graphical user interface or a web browser through which a user may interact with an implementation of the systems and technologies described here) which includes a front-end component, or a computing system which includes any combination of such back-end, middleware, or front-end components. The components of the system may be interconnected through any form or medium of digital data communication (for example, a communication network). Examples of the communication network include: a local area network (LAN), a wide area network (WAN) and the Internet.

A computer system may include a client and a server. Generally, the client and the server are remote from each other and interact through the communication network. The relationship between the client and the server is generated by virtue of computer programs which are run on respective computers and have a client-server relationship to each other.

With the technical solution of the embodiments of the present application, after the syntactic dependency tree of the query is matched with the syntactic dependency trees of the preset templates, the slot operator of the slot in the query is marked using the determined target template, such that the logical relationship applied to the slot in the query may be acquired, thereby improving the parsing accuracy of the query; after the slot operator of the slot in the query is parsed, the querying action is performed for the query in conjunction with the contents of the previous query, and therefore, the more accurate querying result is acquired and returned to the user.

It should be understood that various forms of the flows shown above may be used and reordered, and steps may be added or deleted. For example, the steps described in the present application may be executed in parallel, sequentially, or in different orders, and are not limited herein as long as the desired results of the technical solution disclosed in the present application may be achieved.

The above-mentioned embodiments are not intended to limit the scope of the present application. It should be understood by those skilled in the art that various modifications, combinations, sub-combinations and substitutions may be made, depending on design requirements and other factors. Any modification, equivalent substitution and improvement made within the spirit and principle of the present application all should be included in the extent of protection of the present application.

What is claimed is:

1. A method for parsing a query, comprising:
acquiring the query input by a user;
constructing a syntactic dependency tree of the query;
matching the syntactic dependency tree of the query with syntactic dependency trees of preset templates, and determining a target template according to the matching result; and
marking a slot operator of a slot in the query using the target template, wherein the marked slot operator represents a logical relationship applied to the slot in the query.

2. The method according to claim 1, further comprising: before the syntactic dependency tree of the query is constructed,
determining whether the query meets a preset requirement; and
in response to determining that the query meets the preset requirement, continuing to execute the operation of constructing the syntactic dependency tree of the query, and
in response to determining that the query does not meet the preset requirement, parsing the query directly.

3. The method according to claim 1, wherein the constructing a syntactic dependency tree of the query comprises:
performing word segmentation on the query to acquire semantic elements in the query and the part of speech of each semantic element;
performing syntactic dependency analysis on the semantic elements in the query to determine the dependency relationships between the semantic elements; and
constructing the syntactic dependency tree of the query according to the semantic elements in the query, the part of speech of each semantic element and the dependency relationships between the semantic elements.

4. The method according to claim 1, wherein the matching the syntactic dependency tree of the query with syntactic dependency trees of preset templates and determining a target template according to the matching result comprises:
acquiring a query tree diagram according to the syntactic dependency tree of the query, and acquiring a template tree diagram of each template according to the syntactic dependency tree of each preset template; and
after the template tree diagram identical to the query tree diagram is determined, using the preset template corresponding to the determined template tree diagram as the target template.

5. The method according to claim 4, wherein the acquired query tree diagram comprises at least one of: an overall tree diagram of the syntactic dependency tree corresponding to the query, or a subtree diagram of a subtree in the syntactic dependency tree corresponding to the query.

6. The method according to claim 1, further comprising: after the target template is determined according to the matching result,
ranking the target templates with the same names according to the confidence thereof; and
according to the ranking result, reserving the first target templates under different names.

7. The method according to claim 1, wherein the marking a slot operator of a slot in the query using the target template comprises:
making nodes and sides between the nodes in the syntactic dependency tree of the target template to correspond respectively to nodes and sides between the nodes in the syntactic dependency tree of the query; and
acquiring an operator of each node in the syntactic dependency tree of the target template as the slot operator of the slot corresponding to the same node in the syntactic dependency tree of the query.

8. An electronic device, comprising:
at least one processor; and
a memory connected with the at least one processor communicatively;
wherein the memory stores instructions executable by the at least one processor to cause the at least one processor to perform a method for parsing a query, which comprises:
acquiring the query input by a user;
constructing a syntactic dependency tree of the query;
matching the syntactic dependency tree of the query with syntactic dependency trees of preset templates, and determining a target template according to the matching result; and
marking a slot operator of a slot in the query using the target template, wherein the marked slot operator represents a logical relationship applied to the slot in the query.

9. The electronic device according to claim 8, wherein the method further comprises: before the syntactic dependency tree of the query is constructed,
determining whether the query meets a preset requirement; and
in response to determining that the query meets the preset requirement, continuing to execute the operation of constructing the syntactic dependency tree of the query, and
in response to determining that the query does not meet the preset requirement, parsing the query directly.

10. The electronic device according to claim 8, wherein the constructing a syntactic dependency tree of the query comprises:
performing word segmentation on the query to acquire semantic elements in the query and the part of speech of each semantic element;
performing syntactic dependency analysis on the semantic elements in the query to determine the dependency relationships between the semantic elements; and
constructing the syntactic dependency tree of the query according to the semantic elements in the query, the part of speech of each semantic element and the dependency relationships between the semantic elements.

11. The electronic device according to claim 8, wherein the matching the syntactic dependency tree of the query with syntactic dependency trees of preset templates and determining a target template according to the matching result comprises:
acquiring a query tree diagram according to the syntactic dependency tree of the query, and acquiring a template tree diagram of each template according to the syntactic dependency tree of each preset template; and
after the template tree diagram identical to the query tree diagram is determined, using the preset template corresponding to the determined template tree diagram as the target template.

12. The electronic device according to claim 11, wherein the acquired query tree diagram comprises at least one of: an overall tree diagram of the syntactic dependency tree corresponding to the query, or a subtree diagram of a subtree in the syntactic dependency tree corresponding to the query.

13. The electronic device according to claim 8, wherein the method further comprises: after the target template is determined according to the matching result,
ranking the target templates with the same names according to the confidence thereof; and
according to the ranking result, reserving the first target templates under different names.

14. The electronic device according to claim 1, wherein the marking a slot operator of a slot in the query using the target template comprises:
making nodes and sides between the nodes in the syntactic dependency tree of the target template to correspond respectively to nodes and sides between the nodes in the syntactic dependency tree of the query; and
acquiring an operator of each node in the syntactic dependency tree of the target template as the slot operator of the slot corresponding to the same node in the syntactic dependency tree of the query.

15. A non-transitory computer readable storage medium with computer instructions stored thereon, wherein the computer instructions are used for causing a computer to perform a method for parsing a query, which comprises:
acquiring the query input by a user;
constructing a syntactic dependency tree of the query;
matching the syntactic dependency tree of the query with syntactic dependency trees of preset templates, and determining a target template according to the matching result; and
marking a slot operator of a slot in the query using the target template, wherein the marked slot operator represents a logical relationship applied to the slot in the query.

16. The non-transitory computer readable storage medium according to claim 15, wherein the method further comprises: before the syntactic dependency tree of the query is constructed,
determining whether the query meets a preset requirement; and
in response to determining that the query meets the preset requirement, continuing to execute the operation of constructing the syntactic dependency tree of the query, and
in response to determining that the query does not meet the preset requirement, parsing the query directly.

17. The non-transitory computer readable storage medium according to claim 15, wherein the constructing a syntactic dependency tree of the query comprises:
performing word segmentation on the query to acquire semantic elements in the query and the part of speech of each semantic element;
performing syntactic dependency analysis on the semantic elements in the query to determine the dependency relationships between the semantic elements; and
constructing the syntactic dependency tree of the query according to the semantic elements in the query, the part of speech of each semantic element and the dependency relationships between the semantic elements.

18. The non-transitory computer readable storage medium according to claim 15, wherein the matching the syntactic dependency tree of the query with syntactic dependency trees of preset templates and determining a target template according to the matching result comprises:
acquiring a query tree diagram according to the syntactic dependency tree of the query, and acquiring a template tree diagram of each template according to the syntactic dependency tree of each preset template; and
after the template tree diagram identical to the query tree diagram is determined, using the preset template corresponding to the determined template tree diagram as the target template.

19. The non-transitory computer readable storage medium according to claim 18, wherein the acquired query tree diagram comprises at least one of: an overall tree diagram of the syntactic dependency tree corresponding to the query, or a subtree diagram of a subtree in the syntactic dependency tree corresponding to the query.

20. The non-transitory computer readable storage medium according to claim 15, wherein the method further comprises: after the target template is determined according to the matching result,
ranking the target templates with the same names according to the confidence thereof; and
according to the ranking result, reserving the first target templates under different names.
